(19) United States
(12) Patent Application Publication
(10) Pub. No.: US 2017/0118922 A1
(43) Pub. Date: May 4, 2017

(54) Power and Lighting System for Vertical Growing Carousel

(71) Applicant: Seros LLC, Bealeton, VA (US)

(72) Inventor: Tristyn Sherertz, Bealeton, VA (US)

(73) Assignee: Seros LLC, Bealeton, VA (US)

(21) Appl. No.: 15/337,199

(22) Filed: Oct. 28, 2016

Related U.S. Application Data
(60) Provisional application No. 62/248,748, filed on Oct. 30, 2015.

(51) Int. Cl. A01G 9/02; A01G 27/00; A01G 7/04; A01C 23/00

(52) U.S. Cl. CPC A01G 9/023; A01C 23/007; A01G 27/003; A01G 7/045

(57) ABSTRACT

Disclosed is a vertical growing carousel including a first upright member, a first drive gear associated with the first upright member, a first chain connected to the drive gear, a first plurality of support brackets connected to the first chain, a second upright member opposite the first upright member, a second drive gear associated with the second upright member, a second chain connected to the second drive gear, a second plurality of support brackets connected to the second chain, a driveshaft extending between the first upright member and the second upright member, a motor connected to the driveshaft, a plurality of growing trays, each growing tray respectively comprising, a substantially flat base, a plurality of upstanding sidewalls extending, up from the flat base, a plurality of electrical contacts for receiving electrical power, and at least one light on a bottom side of the base.

### BACKGROUND OF THE INVENTION

This application is a non-provisional of U.S. Provisional Application 62/248,748 filed Oct. 30, 2015 the entirety of which is hereby incorporated by reference.

Field of the Invention

The embodiments of the invention relate indoor horticulture equipment, and more particularly, to a motorized vertical growing carousel. Although embodiments of the invention are suitable for a wide scope of applications, it is particularly suitable for growing herbs and vegetables for personal consumption in the home.

Discussion of the Related Art

Generally, growing plants for personal consumption requires approximately 18″ of vertical space above the growing surface to allow the plants to grow. A standard growing operations wastes space because overhead space is not fully utilized.

Various embodiments of vertical growing carousels exist in the prior art to effectively allow growing areas to be “stacked” thus more efficiently utilizing vertical space, narrowing the growing footprint, and increasing plant density. A vertical growing carousel generally includes a plurality of growing areas mounted on a rack. A vertical growing carousels have a drive system to rotate the growing areas around the carousel and provide a user quick and easy access to all growing areas. A vertical growing carousel can increase space efficiency of horticultural operations because plants can effectively be stacked upon each other.

The related art includes a variety of vertical growing carousels such as those disclosed in U.S. Pat. Nos. 7,559,173, 7,984,586, and 7,415,796 to Nicholas Gordon Brusatore (collectively, “Brusatore”). Brusatore discloses generally, a series of pods mounted on a vertical carousel. The inside faces of the pods have cutouts for receiving seedlings. A light is disposed in the center of the pod to provide light to the seedlings. The related art also includes U.S. Pat. No. 3,529,379 to Richard Louis Ware (“Ware”). Ware discloses generally, a vertical growing carousel having a panel of fluorescent tubes disposed in a central area of the carousel.

One of the problems with the related art vertical growing carousels, however, is that that when growing areas are stacked, it is difficult to evenly disperse light to all of the plants. Brusatore attempts to address this problem by designing the growing areas as enclosed pods each having a central light source. Brusatore, however, is primarily directed to germination and preliminary growing of seedlings, not full scale growing because the plants would quickly grow into each other. Ware has an alternative approach to Brusatore and provides, generally, open growing areas. Ware however, suffers from an uneven distribution of light because the light source in Ware is centrally located and plants on an exterior of the carousel are not exposed to as much light as the interior of the carousel. Thus, there is a need for a vertical growing carousel that provides even and consistent light to its respective growing areas that is not addressed by the related art.

### SUMMARY OF THE INVENTION

Accordingly, embodiments of the invention are directed to a power and lighting system for vertical growing carousel that substantially obviates one or more of the problems due to limitations and disadvantages of the related art.

An object of embodiments of the invention is to provide a vertical growing carousel for herbs and vegetables.

Another object of embodiments of the invention is to provide an even lighting system for a vertical growing carousel.

Yet another object of embodiments of the invention is to provide a power delivery system for the lighting of a vertical growing carousel.

Still another object of embodiments of the invention is to provide automated provision of water and nutrients.

Another object of embodiments of the invention is to provide detection of water and soil conditions within a vertical growing carousel.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a power and lighting system for a vertical growing carousel includes a first upright member, a first drive gear associated with the first upright member, a first chain connected to the drive gear, a first plurality of support brackets connected to the first chain, a second upright member opposite the first upright member, a second drive gear associated with the second upright member, a second chain connected to the second drive gear, a second plurality of support brackets connected to the second chain, a driveshaft extending between the first upright member and the second upright member, a motor connected to the driveshaft, a plurality of growing trays, each growing tray respectively comprising, a substantially flat base, a plurality of upstanding sidewalls extending, up from the flat base, a plurality of electrical contacts for receiving electrical power, and at least one light on a bottom side of the base.

In another aspect, a power and lighting system for a vertical growing carousel includes a growing tray having a substantially flat base, a plurality of upstanding sidewalls extending up from the flat base forming a reservoir, a plurality of electrical contacts for receiving electrical power; and at least one light on a bottom side of the flat base.

In yet another aspect, a power and lighting system for a vertical growing carousel includes a first upright member, a first upper and lower drive gear associated with the first upright member, a first chain connected to the first upper and lower drive gear, a first plurality of support brackets connected to the first chain, a second upright member opposite the first upright member, a second upper and lower drive gear associated with the second upright member, a second chain connected to the second upper and lower drive gear, a second plurality of support brackets connected to the second chain, a driveshaft extending between the first upright member and the second upright member, the driveshaft disposed outside of the area defined by a perimeter of the first and second chains, a motor connected to the driveshaft, a plurality of growing trays, each growing tray respectively including a substantially flat base, a plurality of upstanding sidewalls extending up from the flat base to form a reservoir, a plurality of electrical contacts for receiving electrical power, and at least one light on a bottom side of the base, a rotary electrical connector for supplying electrical power to one of the plurality of growing trays, wherein the rotary electrical connector is one of the first plurality of support brackets.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an illustration of a vertical growing carousel according to an exemplary embodiment of the invention;

FIG. 2 is an illustration of a drive system for a vertical growing carousel according to an exemplary embodiment of the invention

FIG. 3A is an illustration of a tray for a vertical growing carousel according to an exemplary embodiment of the invention;

FIG. 3B is an illustration of a tray for a vertical growing carousel according to an exemplary embodiment of the invention;

FIG. 4 is an illustration of a support frame for a tray for a vertical growing carousel according to an exemplary embodiment of the invention;

FIG. 5 is an illustration of an electrical system for a vertical growing carousel according to an exemplary embodiment of the invention;

FIG. 6 is an illustration of an electrical system for a vertical growing carousel according to an exemplary embodiment of the invention;

FIG. 7 is an illustration of a nutrient delivery system of a vertical growing carousel according to an exemplary embodiment of the invention;

FIG. 8 is an illustration of a controller for a vertical growing carousel according to an exemplary embodiment of the invention; and

FIG. 9 is an illustration of a rotary connector according to an exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

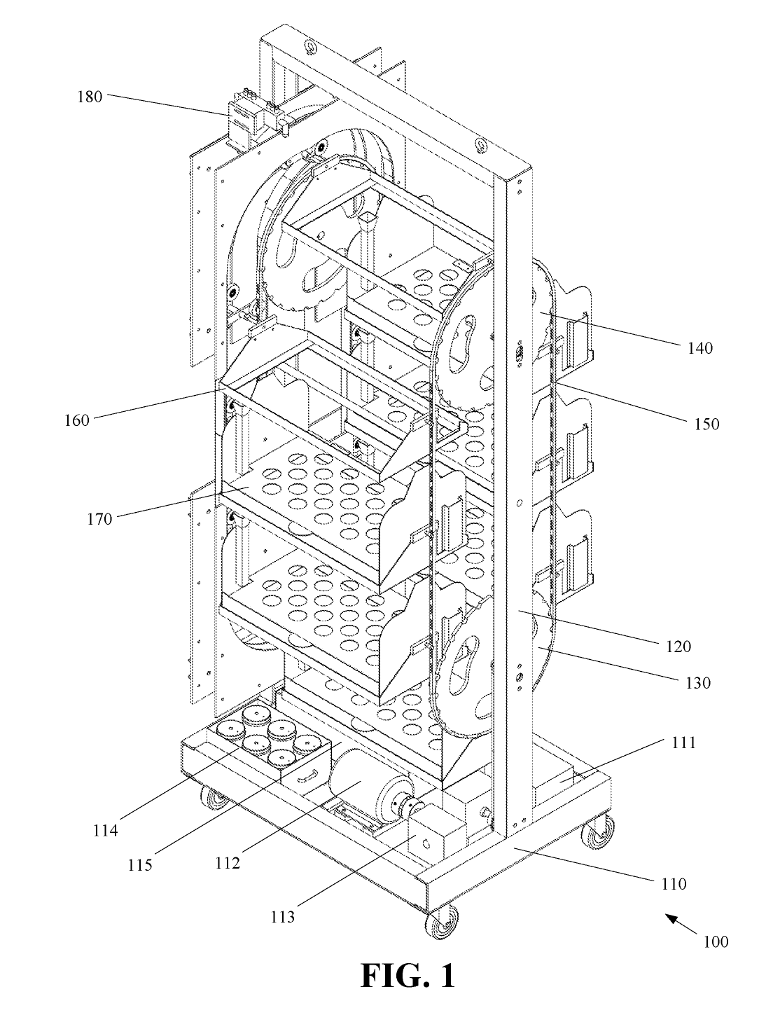

FIG. 1 is an illustration of a vertical growing carousel according to an exemplary embodiment of the invention. As shown in FIG. 1, a vertical growing carousel 100 includes a base 110, a frame 120, a drive gears 130 and 140, a drive belt 150, a tray frame 160, a growing tray 170, and a liquid dispenser 180. The base 110 includes a power supply 111, a motor 112, a gearbox 113, a nutrient supply 114, and a water supply 115. The vertical growing carousel 100 can include multiple tray frames 160 and multiple growing trays 170 although only one example of each has been labeled in FIG. 1 for clarity.

The frame can support drive gears 130 and 140. The motor 112 can be connected to the gearbox 113. The gearbox can be connected to the drive gear 130 by a belt or gears (not shown). The power supply can provide power to the motor 112 causing the armature (not labeled) of motor 112 to rotate, thereby imparting a rotary force on the drive gear 130. The drive gear 130 can be connected to the second drive gear 140 via drive belt 150. Each of the tray frames 170 can be connected to drive belt 150. Thus, the motor 112 can cause the tray frames 160 and the growth trays 170 therein to rotate along the same path as the drive belt 150.

Although drive gears 130 and 140 and drive belt 150 on the right side of the vertical growing carousel 100 are described in conjunction with FIG. 1, is should be appreciated that similar structure can be implemented on the opposite or left-hand side of the vertical growing carousel 100.

The vertical growing carousel 100 can be configured to rotate each of the tray frames 160 and the corresponding trays 170 into position to receive liquid from the liquid dispenser 180. The liquid can include water from the water supply 115 or nutrients (e.g. fertilizer) from the nutrient supply 114. Liquid can be dispensed from the water supply 115 and nutrient supply 114 through the liquid dispenser 180 via micro pumps and tubing (not shown).

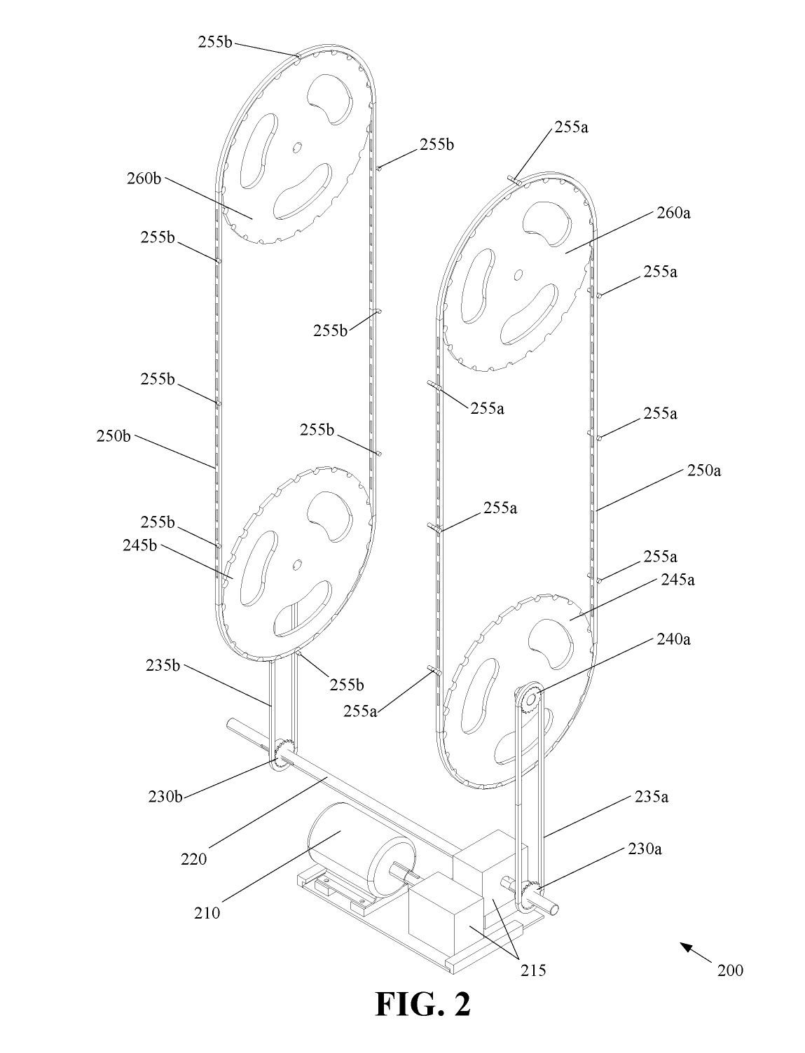

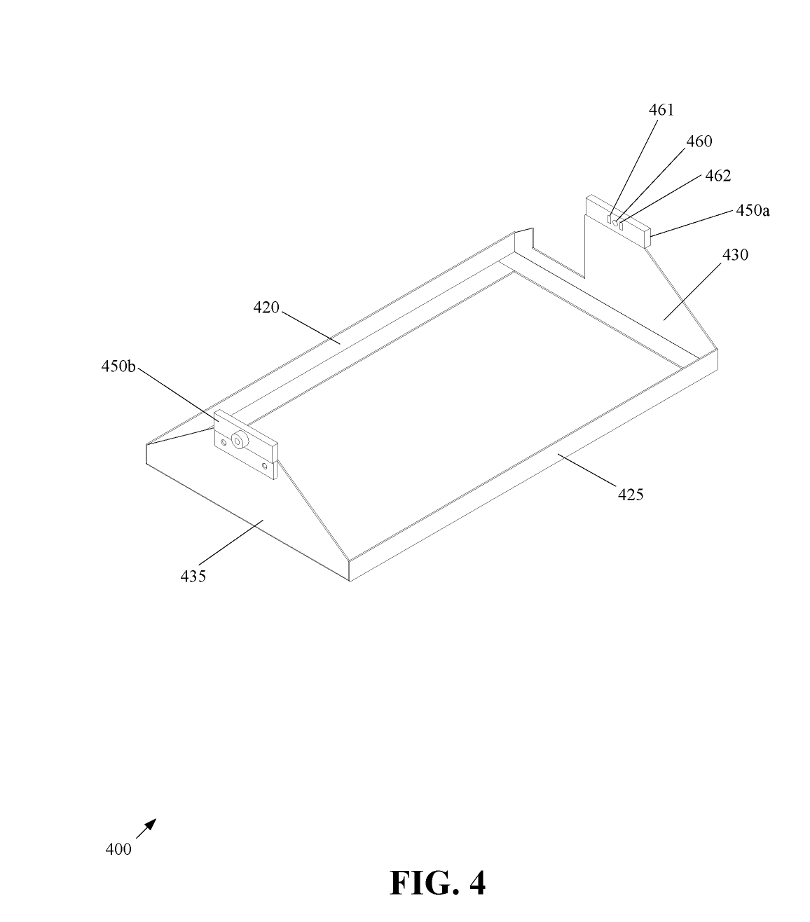

FIG. 2 is an illustration of a drive system for a vertical growing carousel according to an exemplary embodiment of the invention. As shown in FIG. 2, the drive system 200 includes a motor 210, a gearbox 215, a drive shaft 220, two drive shaft gears 230a and 230b, and two belts 235a and 235b. The drive system 200 can further include two lower drive gears 245a and 245b each having a transfer gear 240a (only one shown). The drive system 200 can further include two drive belts 250a and 250b (sometimes called “chains”) and two upper drive gears 260a and 260b. Each drive belt 250a and 250b can further include a plurality of brackets or support pins 255a and 255b. The plurality of brackets or support pins 255a and 255b can support a tray frame as will be more particularly described in conjunction with FIG. 4.

The motor 210 can be connected to the gear box 215. The gear box can provide a reduction in rotational speed of the motor 210 and a proportional increase in power. The gear box 215 can be connected to the drive shaft 220. The drive shaft 220 can include two drive shaft gears 230a and 230b. When the drive shaft 220 is rotated, the two drive shaft gears 230a and 230b can be rotated in unison thereby imparting a rotational force on the belts 235a and 235b. The belts 235a and 235b can be connected to a transfer gear (e.g. 240a) of each of the lower drive gears 245a and 245b. The lower drive gears 245a and 245b can be connected to the upper drive gears 260a and 260b via drive belts 250a and 250b, respectively. Rotation of the motor 210 can cause the entire drive system 200 to rotate as can be seen in the illustration of FIG. 2. When the drive belts 250a and 250b rotate, support brackets or support pins 255a and 255b rotate with their respective drive belts 250a and 250b. Tray frames or trays can be connected to the support brackets or support pins 255a and 255b.

In preferred embodiments of the invention, the driveshaft 220 is disposed in or near a base (not labeled) of the vertical growing carousel, or at any event, disposed in the area outside of the perimeter defined by the drive belts 250a and 250b. This is a preferred embodiment because in these location, the drive shaft 220 is unlikely to interfere with the intended operation of the vertical growing carousel. For example, if the drive shaft 220 were alternatively located in a connecting position between lower drive gears 245a and 245b, a plant growing in a growing tray (not labeled) at the lowest point in the carousel would be likely to be damaged by or become tangled on the drive shaft. In another example, if the drive shaft 220 were located in a connecting position between lower drive gears 245a and 245b, electrical lines supplying power to the growth trays could become tangled on the drive shaft.

Although the support brackets or support pins 255a and 255b have been illustrated substantially as cylindrical protrusions from their respective drive belts 250a and 250b, the size and shape of these support brackets or support pins 255a and 255b can be adapted as necessary to support a heavier or lighter growing tray and frame. U.S. Pat. No. 3,909,978 to Fleming describes one such support bracket, the entirety of which is hereby incorporated by reference. In embodiments of the invention where the growing tray and frame are anticipated to be heavy, the belt can be reinforced with stiffening members or guides to prevent or limit deflection or sagging.

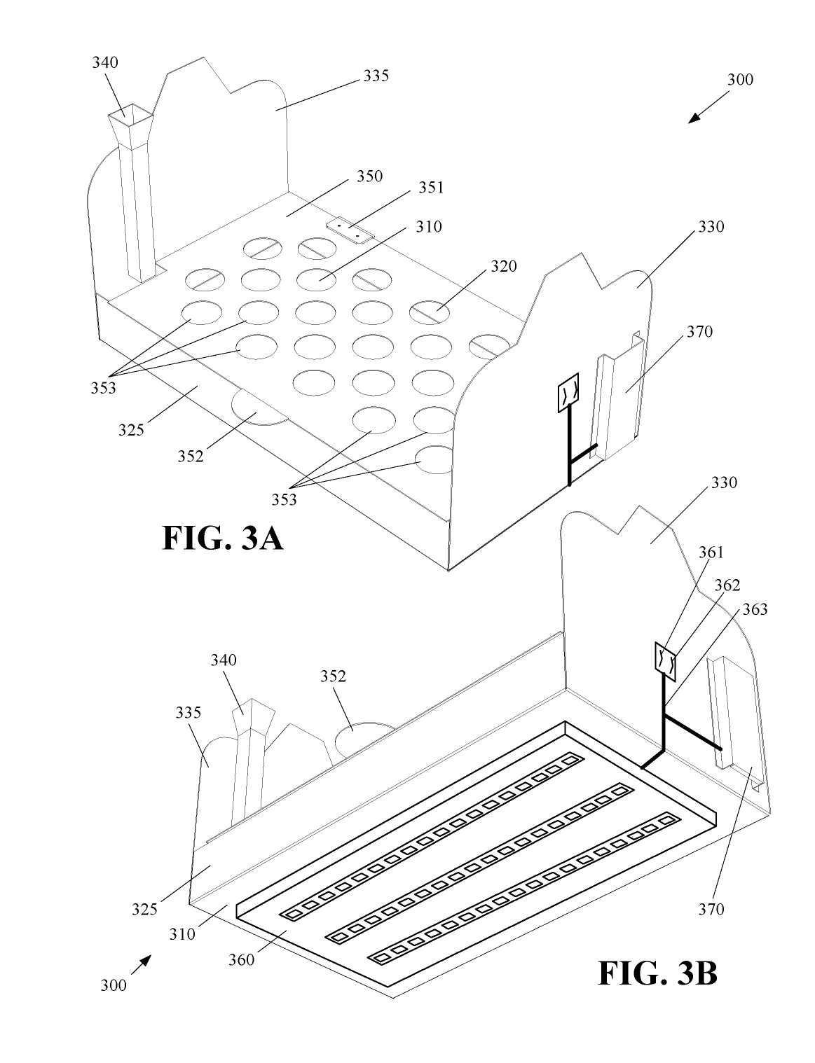

FIG. 3A and FIG. 3B are illustrations of a tray for a vertical growing carousel according to an exemplary embodiment of the invention. As shown in FIG. 3A and FIG. 3B, a tray for a vertical growing carousel 300 includes a base 310, a plurality of sidewalls 320, 325, 330, and 335. Together the base 310 and the sidewalls 320, 325, 330, and 335 can form a reservoir area suitable for retaining a liquid. The tray can include a funnel 340 for receiving a liquid and routing the liquid into the reservoir area. The tray 300 can further include a pod rack 350. The pod rack 350 can be connected to one of the sidewalls (e.g. 320) via a hinge 351 allowing the pod rack 350 to be hingedly lifted from the tray and allowing access to the reservoir area (not labeled) for cleaning and maintenance purposes. The pod rack 350 can include a tab 352 for easily lifting the pod rack 350. The pod rack 350 can include a plurality of holes 353 for receiving plant pods or plant starts.

The underside of the base 310 can include a light 360. The light 360 can provide lighting for a tray disposed below the tray 300. In preferred embodiments of the invention, the light 360 is a plurality of LED lights in a panel although other lights sources are contemplated including incandescent lighting, florescent lighting, and other configurations of LED lighting such as strips, domes, and even single-element LEDs.

The growing tray 370 can further include an electronics package 370. The electronics package 370 can include communication electronics and sensors. The electronics package 370 can include a moisture sensor for detecting the amount of moisture in the reservoir area. The electronics package 370 can include a water level sensor for determine a water level in the reservoir area. The electronics package 370 can include an RFID tag to identify the tray. The electronics package 370 can include a communication electronics to communicate the status of the sensors to a central controller (not shown). The communications electronics can be wired or wireless using known technologies such as Bluetooth or 802.11. The electronics package 370 can include an energy storage device (e.g. batteries) to supply power to the components of the electronics package 370 and the light 360 during a power failure.

The electronics package 370 can further include an inductive power receiver (not shown) to power the components of the electronics package 370 and the light 360. As the growing trays 300 are rotated about the vertical growing carousel, the electronics package 370 and the inductive power receiver can pass inductive power transmitters (not shown) positioned throughout the vertical growing carousel.

The growing tray 300 can include an electrical connector having contacts 361 and 362 for receiving electrical power. Electrical power can be transmitted to the light 360 and the electronics package 370 via wire 363. In embodiments of the invention, the electrical contacts 361 and 362 can correspond in size and position to electrical contacts on a tray support frame as shown in the example of FIG. 4. In other embodiments of the invention, the electrical contacts 361 and 362 can correspond in size and position to electrical contacts on support brackets such as those discussed in conjunction with FIG. 2. In still another embodiment, the electrical contacts 361 and 362 can be formed as part of an electrical connector (e.g. a plug or a port) or solder point.

FIG. 4 is an illustration of a support frame for a tray for a vertical growing carousel according to an exemplary embodiment of the invention. As shown in FIG. 4, the support frame 400 includes tray supports 420 and 425 and sidewalls 430 and 435. The sidewalls 430 and 435 include coupling brackets 450a and 450b, respectively. The coupling brackets 450a and 450b can receive the brackets or support pins described in conjunction with FIG. 2. The coupling bracket 450a can include a socket 460 and electrical contacts 461 and 462. In embodiments of the invention, a connector (such as a connector formed in the brackets or support pins described in conjunction with FIG. 2) can be received in the socket 460. The socket 460 can be similar in design to a standard ⅛″ headphone jack common on audio players. The socket 460 can be electrically connected to contacts 461 and 462.

The contacts 461 and 462 can correspond in size and location to contacts on a tray to be received in the support frame 100. For example, the tray shown and described in conjunction with FIG. 3A and 3B can be received in the support frame of FIG. 4. The tray contacts 461 and 462 can correspond in size and location to contacts 361 and 362 of FIG. 3B.

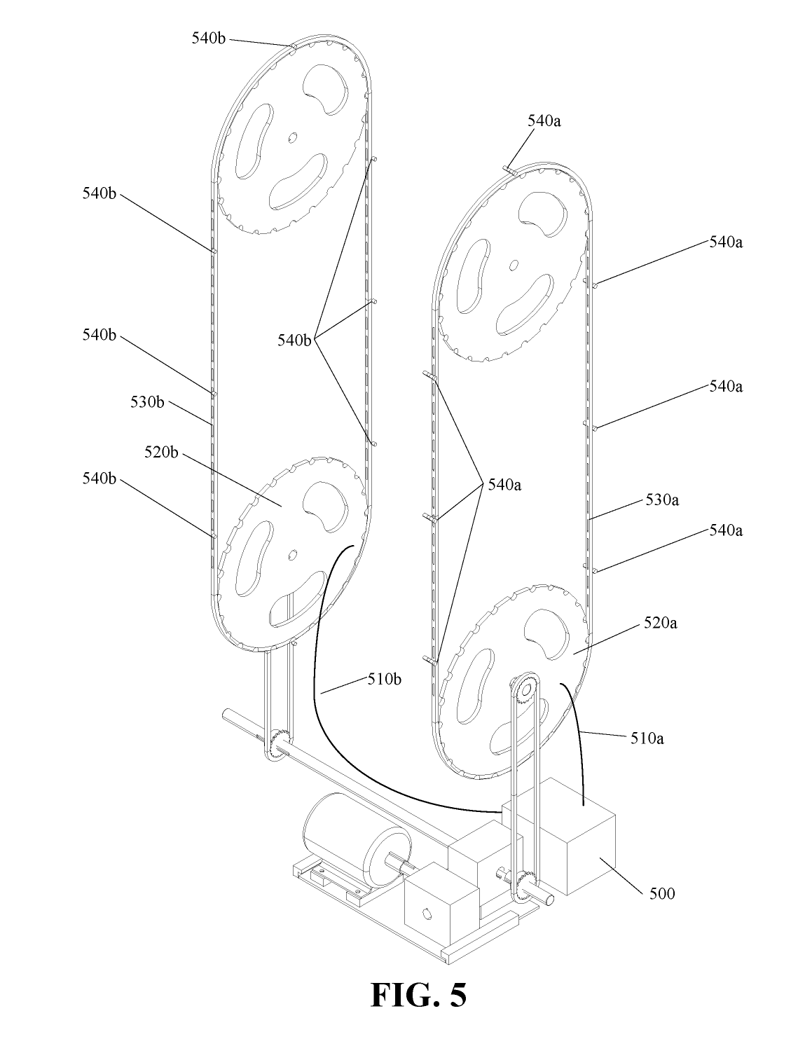

FIG. 5 is an illustration of an electrical system for a vertical growing carousel according to an exemplary embodiment of the invention. As shown in FIG. 5, the electrical system includes a power supply 500, two power lines 510a and 510b, two lower drive gears 520a and 520b, drive belts 530a and 530b, and two corresponding pluralities of support pins 540a and 540b.

In operation, a positive electrical charge can be applied to one side of the drive system, for example, via power line 510a applied to lower drive gear 520a. The lower drive gear 520a can be connected to drive belt 530a and support pins 540a. Each of the lower drive gear 520a, the drive belt 530a, and support pins 540a (“Right Side”) can be formed from an electrically conductive material thereby allowing a positive electrical charge to flow through the aforementioned components. Similarly, a negative terminal of the power supply 500 can be connected to lower drive gear 520b via power line 510b. Lower drive gear 520b, drive belt 530b, and support pins 540b (“Left Side”) can be formed from an electrically conductive material. A tray frame or tray, such as those disclosed in conjunction with FIGS. 3A, 3B, and 4, can be connected between respective support pins 540a and 540b thereby providing electrical power to each of the trays (not shown).

Although the power lines 510a and 510b are shown as directly connected to the lower drive gears 520a and 520b, it should be appreciated that FIG. 5 is for illustration purposes only and that additional structures that are known in the art to connect an electrical contact to a rotating object could be utilized to efficiently achieve the desired connection. One such structure is a “brush” as is commonly known in the art of electric motors. In exemplary embodiment, a brush could be attached to each side of the frame 120 (FIG. 1) and held in contact with the respective rotating lower drive gears 520a and 520b.

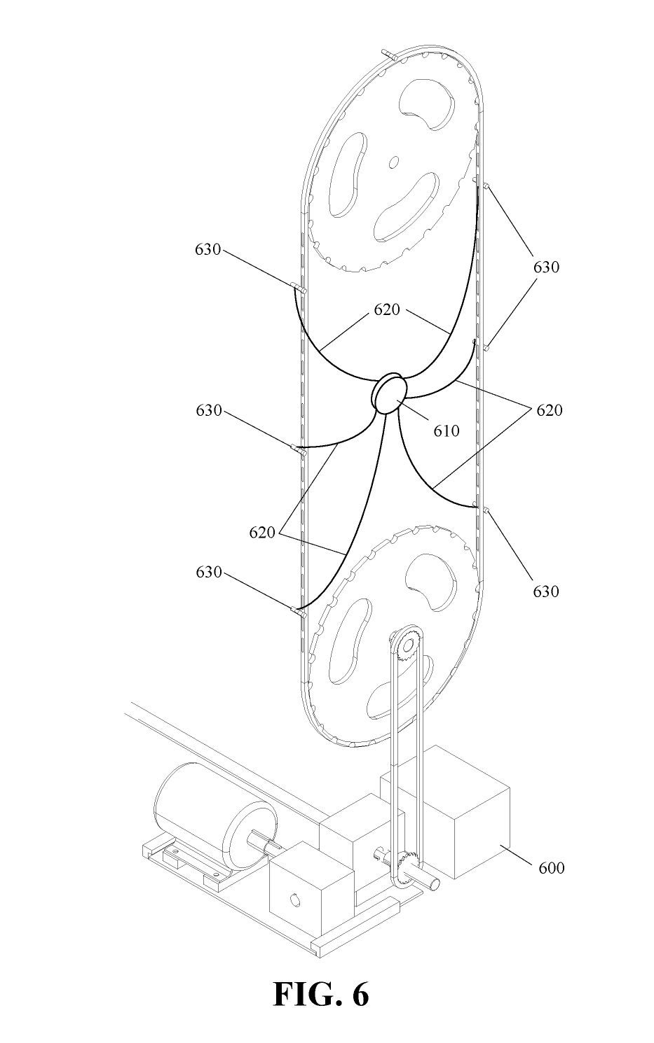

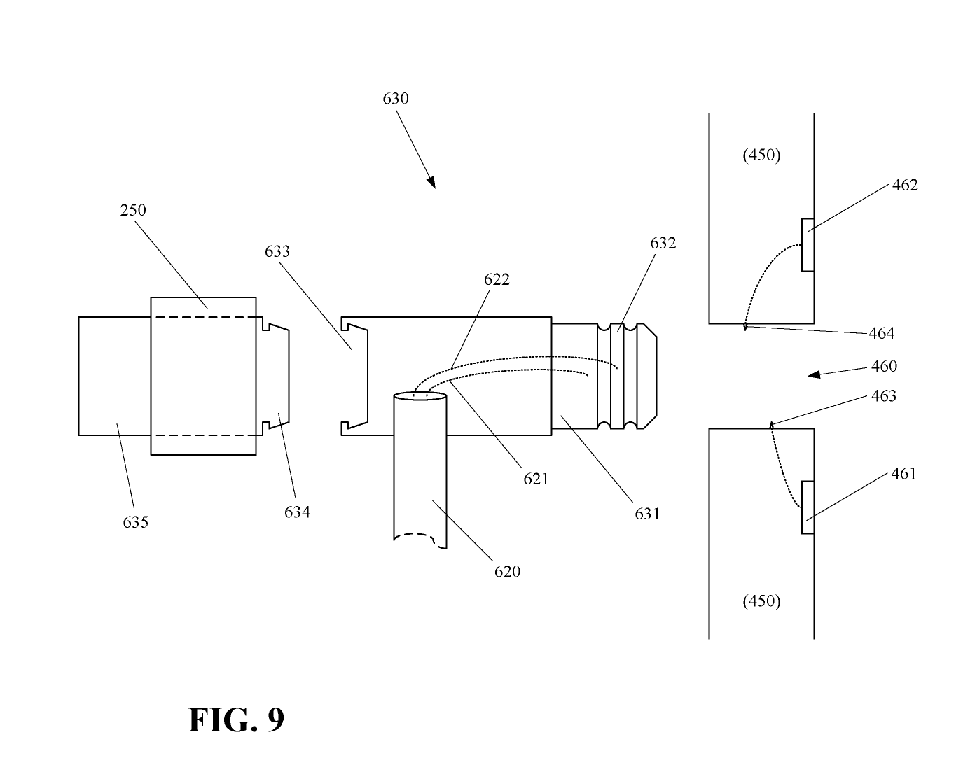

FIG. 6 is an illustration of an electrical system for a vertical growing carousel according to an exemplary embodiment of the invention. As shown in FIG. 6, a hub 610 can be connected via power lines 620 to support pins 630. The support pins 630 can also function as support brackets or support pins for holding a tray (e.g. FIGS. 3A and 3B) or a tray frame (e.g. FIG. 4). The support pins 630 can be rotary connectors as more particularly described in conjunction with FIG. 9.

In an embodiment, the hub 610 can be rotably mounted on the frame 120 (FIG. 1). The hub 610 can rotate passively with the carousel to prevent the power lines 620 from becoming twisted or wrapped around the hub. The hub 610 can be connected to the power supply 600. The power lines 620 can be stretchable power lines, such as the iStretch sold by Minnesota Cable.

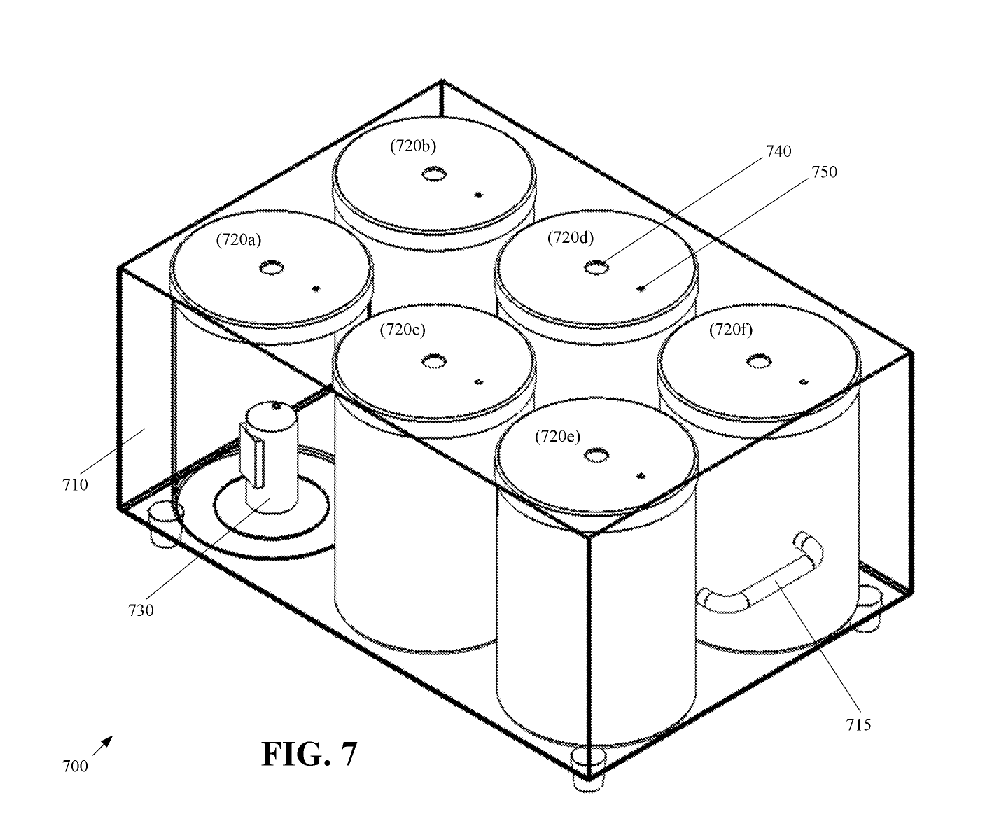

FIG. 7 is an illustration of a nutrient delivery system of a vertical growing carousel according to an exemplary embodiment of the invention. As shown in FIG. 7, the nutrient delivery system 700 can include a chassis 710, a handle 715, and a plurality of nutrient storage containers 720a-f. Each of the nutrient storage containers 720a-f can include a micropump such as micropump 730 shown inside nutrient storage container 720a. Each of the nutrient storage containers 720a-f can include a lid having a tube-hole 740 and a vent hole 750. The tube-hole 740 can allow a tube (not shown) to connect to the micropump (e.g. 730) and to the liquid dispenser 180 of FIG. 1. The nutrient storage containers 720a-f can be filled with various liquid fertilizers. In embodiments of the invention, each of the growing trays can include different plants and certain plants can be provided an optimal fertilizer from one or more of the nutrient storage containers 720a-f.

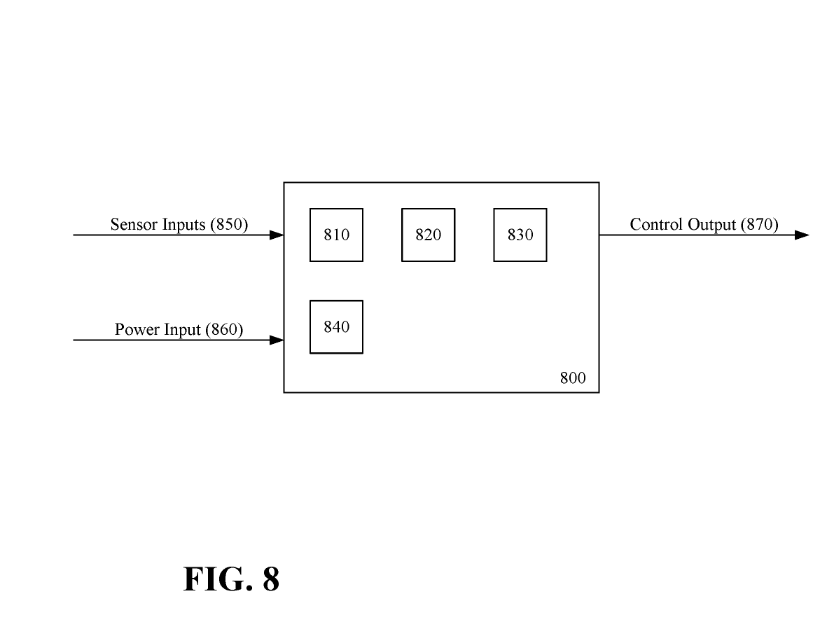

FIG. 8 is an illustration of a controller for a vertical growing carousel according to an exemplary embodiment of the invention. As shown in FIG. 8, a controller 800 includes a processor 810, a memory 820, a communications module 830, and a plurality of relay modules 840. The controller 800 can receive electrical power on input 860 and sensor inputs on input 850. The controller 800 can send control signals on output 870.

The processor 810 can be a general purpose computing processor that is configured to perform specific instructions stored in the memory 820. The processor 810 can communicate with the communications module 830 to send and receive signals from remote units such as sensors. The communications module 830 can be any type of wired or wireless communications module such as cellular, Bluetooth, 802.11, zigbee, zwave, USB, serial, lwire, firewire, RFID, etc. The relay modules 840 can be connected to the controller and one or more of the pumps, motors, or lights (not shown). The relay modules 840 can allow the controller 800 to provide a low-voltage, low-current signal to one of the relay modules which, in response, can provide high-voltage, high-current power to a motor such as the carousel motor shown in FIG. 2.

The sensor inputs 850 can be wired or wireless. The sensor inputs 850 can be, for example, a signal from a moisture sensor in one of the growing trays, a signal from a switch or button to rotate the vertical carousel, a signal from an ambient light sensor, a signal from a fluid level sensor in a water storage tank or a nutrient storage tank, or a signal from a position sensor associated with a growing tray.

The outputs 870 can be wired or wireless. The outputs 870 can be, for example, control signals to start or stop the motor, control signals to start or stop one of the nutrient pumps, control signals to start or stop the water pump, control signals to turn off the lights of the growing trays.

In one example, the controller 800 can detect when the signal from an ambient light sensor indicates that the ambient light is above a predetermined threshold and, in response, send an output signal to cause the under-lights of the trays to turn off to conserve power. In another example, the controller 800 can detect a signal from a switch indicates that a tray is properly positioned under the fluid dispenser and, in response, cause a predetermined amount of one or more nutrients or water to be dispensed. In preferred embodiments, the controller can cause water can be dispensed until the controller receives a signal from a moisture sensor that the reservoir of a tray is filled.

FIG. 9 is an illustration of a rotary connector according to an exemplary embodiment of the invention. The rotary connector can be used as a support pin or support bracket in embodiments of the invention. As shown in FIG. 9, a rotary connector 630 is substantially cylindrical and includes first electrical contact 631 and a second electrical contact 632. The rotary connector 630 can be configured to receive a cable 620 such as a cable from the hub described in conjunction with FIG. 6. In embodiments of the invention, the cable 620 can have two conductors 621 and 622 that can be electrically connected to electrical contacts 631 and 632, respectively. Although the connection of conductors 621 and 622 to contacts 631 and 632 has been shown as a direct connection of wires for illustrative purposes, those of skill in the art will appreciate that many types of interconnections are easily substituted including interconnections using standard or non-standard plugs and sockets, screws, solder points, or wire leads and thus the invention is not limited to the illustrated embodiments.

The rotary connector 630 can be sized to be received in a socket 460 of a coupling bracket 450 of a tray or tray support frame such as illustrated in conjunction with FIG. 4. The socket 460 of the coupling bracket 450 can include electrical contacts 463 and 464 that are positioned to correspond to electrical contacts 632 and 631 of the rotary connector, respectively. The rotary connector 630 and the socket 460 can be substantially cylindrical so that the rotary connector 630 can spin within the socket 460 while maintaining electrical contact between contacts 463 and 464 and contacts 632 and 631, respectively. The coupling bracket 450 can further include electrical contact points 462 and 461 that are electrically connected to contacts 464 and 463 (respectively) to transfer electrical power. In this way, the tray or tray support frame can provide electrical power to its various electrical components such as lights, sensors, and communications equipment. Although the electrical contact points 462 and 461 have been illustrated as flat pad-style contacts, the electrical contact points 462 and 461 could be embodied as a standard or non-standard electrical connector such as USB or 9-pin serial.

The rotary connector 630 can further include a rear portion 633 for connecting to a coupling member 635 connected to a drive belt 250 of the vertical growing carousel. The rear portion 633 of the rotary connector 630 can be configured to retain a mating portion 634 of the coupling member 635. When so retained, the joint formed by rear portion 633 and mating portion 634 can rotate. In this way, the cable 620 can be prevented from becoming wrapped around the rotary connector 630 when the vertical carousel is operated.

Although the cable 620 of the rotary connector 630 is disclosed in this embodiment as attaching to a side of the rotary connector 630 and the rotary connector 630 further includes a rotary joint formed by rear portion 633 and the mating portion 634, this invention is not limited to the specific disclosed rotary connector and other types of rotary connectors are contemplated and would function with embodiments of the invention. In one alternative example (not shown), a cable can be connected to a support pin by a ring-style rotary where the ring has contact points on its interior and the support pin has contact points about its exterior. Additional rotary connectors, such as those disclosed in any of U.S. Pat. Nos. 7,297,002, 6,764,326, 3,914,715, 7,802,992, 7,223,104, 6,712,618, 5,484,294 are also contemplated, the entirety of which are hereby incorporated by reference.

It will be apparent to those skilled in the art that various modifications and variations can be made in a power and lighting system for a vertical growing carousel without departing from the spirit or scope of the invention. Thus, it is intended that embodiments of the invention cover the modifications and variations of this invention provided they come within the scope of the appended claims and their equivalents.

What is claimed is:

1. A vertical growing carousel comprising:
a first upright member;
a first drive gear associated with the first upright member
a first chain connected to the drive gear;
a first plurality of support brackets connected to the first chain;
a second upright member opposite the first upright member;
a second drive gear associated with the second upright member;
a second chain connected to the second drive gear;
a second plurality of support brackets connected to the second chain;
a driveshaft extending between the first upright member and the second upright member;
a motor connected to the driveshaft;
a plurality of growing trays, each growing tray respectively comprising:
a substantially flat base;
a plurality of upstanding sidewalls extending up from the flat base;
a plurality of electrical contacts for receiving electrical power; and
at least one light on a bottom side of the base.

2. The vertical growing carousel of claim 1 further comprising:
a power supply;
a rotatable hub electrically connected to the power supply;
a plurality of rotary electrical connectors associated with each of the first plurality of support brackets and for providing electrical power to the plurality of growing trays; and
a plurality of power lines, each respectively connected to one of the plurality of rotary electrical connectors and the rotatable hub.

3. The vertical growing carousel of claim 1 further comprising:
a tray support frame disposed between the first upright member and the second upright member, the tray support frame sized to receive one of the plurality of growing trays;
wherein the tray support frame is connected to one of the first plurality of support brackets; and
wherein the tray support frame is further connected to one of the second plurality of support brackets.

4. The vertical growing carousel of claim 1 further comprising:
a controller configured to receive a signal from a sensor in a first tray of the plurality of growing trays, the controller further configured to operate the motor to position the first tray to receive a liquid deposit from a pump, the controller further configured to detect when the first tray is properly positioned and activate the pump, and the controller further configured to deactivate the pump upon dispensing a predetermined amount of the liquid.

5. The vertical growing carousel of claim 4 wherein the liquid is a fertilizer.

6. The vertical growing carousel of claim 4 wherein the sensor is a moisture sensor, the liquid is water, and the predetermined amount is determined in accordance with the signal from the moisture sensor.

7. The vertical growing carousel of claim 1 further comprising:
an ambient light sensor coupled to a controller, the controller configured to disable the at least one light on the bottom of each of the plurality of growing trays.

8. The vertical growing carousel of claim 1 further comprising
a first electrical connector on a first side of each of the plurality of growing trays;
a second electrical connector on a second side of each of the plurality of growing trays;
a power supply having a positive terminal and a negative terminal;
wherein the positive terminal is connected to one of the first chain or the second chain;
wherein the negative terminal is connected to the other of the first chain or the second chain;
wherein the at least one light of each of the plurality of growing trays is electrically connected to the power supply through the first chain via one of the first plurality of support brackets; and
wherein the at least one light of each of the plurality of growing trays is further connected to the power supply through the chain belt via one of the second plurality of support brackets.

9. A growing tray for a vertical growing apparatus, the growing tray comprising:
a substantially flat base;
a plurality of upstanding sidewalls extending up from the flat base forming a reservoir;
a plurality of electrical contacts for receiving electrical power; and
at least one light on a bottom side of the flat base.

10. The growing tray of claim 9 further comprising:
a moisture sensor.

11. The growing tray of claim 9 further comprising:
a wireless transmitter.

12. The growing tray of claim 9 further comprising:
a first wall of the plurality of upstanding sidewalls, the first wall including a first and second electrical contacts.

13. The growing tray of claim 9 further comprising:
a pod rack on top of the substantially flat base.

14. The growing tray of claim 9 further comprising:
a funnel disposed near one of the plurality of upstanding sidewalls, the funnel configured to receive a liquid from an external source and route the liquid to the reservoir.

15. The growing tray of claim 9 further comprising:
a rotary electrical connector connected to the plurality of electrical contacts.

16. The growing tray of claim 9 further comprising:
a tray support frame configured to receive and support the substantially flat base; and
a corresponding plurality of electrical contacts on the tray support from positioned to form an electrical connection with the plurality of electrical contacts.

17. The growing tray of claim 16 further comprising:
a rotary electrical connector connected to the tray support frame.

18. A vertical growing carousel comprising:
a first upright member;
a first upper and lower drive gear associated with the first upright member
a first chain connected to the first upper and lower drive gear;
a first plurality of support brackets connected to the first chain;
a second upright member opposite the first upright member;
a second upper and lower drive gear associated with the second upright member;
a second chain connected to the second upper and lower drive gear;
a second plurality of support brackets connected to the second chain;
a driveshaft extending between the first upright member and the second upright member, the driveshaft disposed outside of an area defined by a perimeter of the first and second chains;
a motor connected to the driveshaft;
a plurality of growing trays, each growing tray respectively comprising:
a substantially flat base;
a plurality of upstanding sidewalls extending up from the flat base to form a reservoir;
a plurality of electrical contacts for receiving electrical power;
at least one light on a bottom side of the base;
a rotary electrical connector for supplying electrical power to one of the plurality of growing trays; and
wherein the rotary electrical connector is one of the first plurality of support brackets.

19. The vertical growing carousel of claim 18 further comprising:
a tray support frame disposed between the first upright member and the second upright member, the tray support frame sized to receive one of the plurality of growing trays;
wherein the tray support frame is connected to one of the first plurality of support brackets; and
wherein the tray support frame is further connected to one of the second plurality of support brackets.

20. The vertical growing carousel of claim 18 further comprising:
a controller configured to receive a signal from a moisture sensor in a first tray of the plurality of growing trays, the controller further configured to operate the motor to position the first tray below a liquid dispenser and to pump water from a water supply through the liquid dispenser, the controller further configured to detect when the first tray is properly positioned below the liquid dispenser and activate the pump, and the controller further configured to deactivate the pump upon dispensing a predetermined amount of water.
